(19) United States
(12) Patent Application Publication
(10) Pub. No.: US 2007/0170018 A1
(43) Pub. Date: Jul. 26, 2007

(54) POSITIVE PAD RETRACTION AND RETENTION DEVICE

(75) Inventor: Derek Alexander, Mequon, WI (US)

Correspondence Address: WHYTE HIRSCHBOECK DUDEK S.C., ONE EAST MAIN STREET, SUITE 300, MADISON, WI, 53703-3300, US

(73) Assignee: HB Performance Systems, Inc., Mequon, WI (US)

(21) Appl. No.: 11/564,023

(22) Filed: Nov. 28, 2006

Related U.S. Application Data
(60) Provisional application No. 60/740,227, filed on Nov. 28, 2005.

(51) Int. Cl. F16D 55/22

(52) U.S. Cl. 188/72.3; 188/73.37

(57) ABSTRACT

A disc brake assembly is provided that includes a disc, a caliper, and a piston having a rear end slidably mounted in a bore in the caliper, a front end that faces the disc, and an inner axial surface. A brake pad is disposed between the piston and the disc. The brake pad has 1) a back plate having front and rear surfaces and 2) a friction pad mounted on the front surface of the back plate. A structure is situated on the rear surface of the back plate. The assembly also has an improved spring clip for holding the brake pad in the assembly. The spring clip is configured to be connectable to the structure on the rear surface of the back plate and engageable with the inner axial surface of the piston.

### CROSS-REFERENCES TO RELATED APPLICATIONS

This application claims priority under 35 U.S.C. §119(e) to U.S. Provisional Patent Application No. 60/740,227, filed Nov. 28, 2005, the entirety of which is incorporated by reference herein.

### FIELD OF INVENTION

The invention relates to disc brake systems and, more particularly, relates to a disc brake system having a brake pad retained in place within the system using a spring clip-type spring clip.

### BACKGROUND OF THE INVENTION

Disc brake systems are used in a wide variety of applications such as bicycles, snowmobiles, golf carts, and automobiles. The typical disc brake system includes 1) a power source, such as a hydraulic master cylinder, and 2) a mechanical disc brake assembly that is actuated by the power source to apply the brake. The disc brake assembly includes a disc that rotates with the wheel, one or more brake pads, and one or more calipers each of which includes at least one piston that is selectively forced towards the disc by the power source to press the brake pad into frictional contact with the disc, thereby applying the braking force.

Within traditional braking environments, brake calipers are actuated to slow or stop a vehicle of some sort. However, when brake system pressure is released, a brake caliper piston pulls back into a brake caliper housing. Friction between the brake pad and brake disc can be reduced when the brake system pressure is released on the brake caliper piston. When this happens, the brake pad is generally free to run with very close proximity to the disc. However, because the brake pads are in such close proximity to the brake disc, these two parts can touch. Disadvantageously, this free running drag can cause losses in speed and generate excess heat by and into the disc. Unfortunately, this condition can deteriorate the condition of the brakes and/or braking system and rendering the same altogether ineffective.

Pad holders are used for installing brake pads of a disc brake assembly. Attempts have been made to address drag and rattling problems and to hold pads tightly against associated pistons. For instance, using pad holders formed from any of a variety of structures such as retainer clips, bolts, and/or fastening lugs are disclosed, for example, in U.S. Pat. No. 5,529,150, GB Patent No. 2,017,236, and GB Patent No. 2,056,601. These pad holders are typically of a relatively complex design, making them rather expensive to fabricate. They also tend to be relatively difficult to remove and install, usually requiring special tools and often requiring partial or complete removal of the caliper and/or disc from the assembly before the pad can be removed from the remainder of the assembly. Many are less than fully effective at holding the pad tight against the associated piston, thereby giving rise to drag and rattling problems.

A spring clip type spring clip is described in U.S. Pat. No. 6,003,639 to James Buckley et al., the disclosure of which is incorporated by reference herein. This spring clip overcomes some of the drawbacks listed above. However, it has several other drawbacks. For example, this type of spring clip must be used with a relatively wide caliper because it requires space in the piston bore for the spring clip to pass. Another drawback of this spring clip is that it is used with a piston having a post. This makes the piston relatively costly to produce. Furthermore, this spring clip is external to the piston, exposing it to dirt, grease, and wear. Lastly, there is only one point of engagement between the spring clip and the piston, increasing the risk of detachment.

In view of the foregoing, it would be desirable to provide a brake assembly that provides at least one of the following advantages when compared to previous brake assemblies: a decreased risk of detachment of the piston and back plate, less expensive to manufacture, that improves fuel economy, that reduces wear on brake pads, improves cooling of the pad, and lowers the virtual inertia of the wheel.

### SUMMARY OF THE INVENTION

The invention, which is defined by the claims set out at the end of this disclosure, is intended to solve at least some of the problems noted above.

A disc brake assembly is provided that includes a disc, a caliper, and a piston having a rear end slidably mounted in a bore in the caliper, a front end that faces the disc, and an inner axial surface. A brake pad is disposed between the piston and the disc. The brake pad has 1) a back plate having front and rear surfaces and 2) a friction pad mounted on the front surface of the back plate. The assembly also has an improved spring clip for holding the brake pad in the brake assembly. The spring clip is configured to be connectable to the rear surface of the back plate and engageable with the inner axial surface of the piston. The spring clip holds the rear surface of the pad tightly against the front surface of the piston or pistons of the caliper to prevent brake drag and brake rattle. The pad can be removed from the brake assembly, without using any special tools, simply by imposing sufficient downward vertical retraction forces on the pad to deflect the spring clip and to remove the pad from the spring clip to which it is attached.

Also provided is a disc brake assembly including a disc, a caliper, and a piston having a rear end slidably mounted in a bore in the caliper, a front end that faces the disc, and an inner axial surface. A brake pad is disposed between the piston and the disc. The brake pad includes 1) a back plate having front and rear surfaces, the back plate including a structure situated on the rear surface of the back plate and 2) a friction pad mounted on the front surface of the back plate. The assembly also includes a spring clip that is configured to be connectable to the structure situated on the rear surface of the back plate and the piston.

In one embodiment, the structure situated on the rear surface of the back plate comprises a finger having a valley and the spring clip includes free ends and a loop disposed between the free ends. The loop is configured to be connectable to the valley of the finger.

In another embodiment, the structure situated on the rear surface of the back plate comprises a post and the spring clip includes a loop that is configured to be connectable to the post.

A method of using the assemblies is also provided. In it, a spring clip is compressed. The compressed spring clip is aligned with a groove on an inner axial surface of a piston of a brake assembly. The compression force on the spring clip is released such that the spring clip fits into the groove of the piston. A brake pad is secured to the spring clip. The securing step comprises connecting a structure on the brake pad to the spring clip.

Other principal features and advantages of the invention will become apparent to those skilled in the art upon review of the following drawings, the detailed description and the appended claims.

### BRIEF DESCRIPTION OF THE DRAWINGS

Many aspects of this invention will be better appreciated and understood in conjunction with the following drawings and description, each of which form integral components of this provisional patent application, in which like reference numerals generally represent like elements, and in which:

FIG. 1 is a partially exploded view of a brake assembly that is constructed in accordance with a first embodiment of the invention.

FIG. 2 is an isometric view of pistons and spring clip of the brake assembly of FIG. 1.

FIG. 3 is an isometric view of the pistons and spring clips of FIG. 2 and a brake pad.

FIG. 4 is an isometric view of one of the spring clips of FIGS. 2 and 3.

FIG. 5 is a partial cross section view of a brake assembly that is constructed in accordance with a second embodiment of the invention.

FIG. 6 is a partial cross section view of the brake assembly of FIG. 5.

FIG. 7 is a partial cross section view of the brake assembly of FIG. 5.

### DETAILED DESCRIPTION

The disc brake assemblies described herein can be used on disc brake assemblies that are mounted on wheels. The disc brake assemblies described herein can be used on motorcycles, bicycles, snowmobiles, ATVs, automobiles, buses, and trucks, ATVs, golf carts, go-karts, and the like. The disc brake assemblies described herein can be used on a dual piston caliper, a single piston caliper, on a caliper having a back plate actuated by two pistons, as is described in U.S. Pat. No. 6,318,514, and on a caliper having a back plate actuated by more than two pistons. The disc brake assemblies will be described herein with respect to dual piston application for convenience sake only. The invention is not limited to this application. The disc brake assemblies described herein can include a fixed caliper or a floating caliper.

### First Embodiment of the Disc Brake Assembly

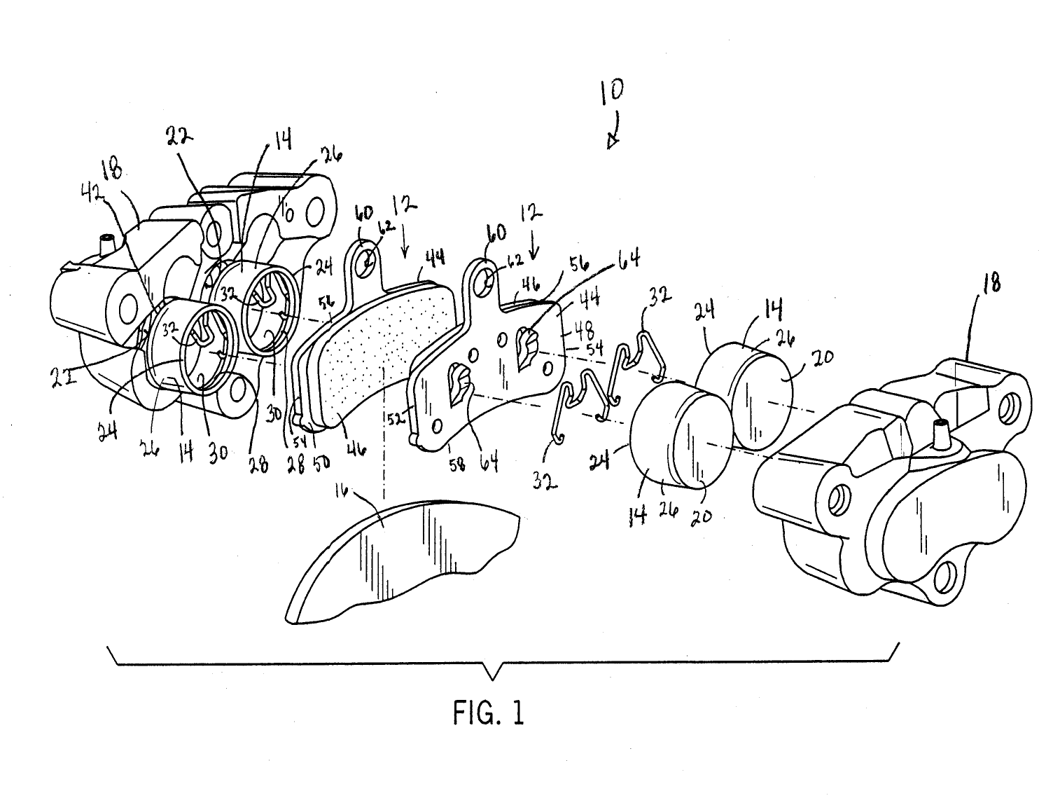

Referring now to FIG. 1, a disc brake assembly 10 made in accordance with a first embodiment is shown. It should be noted that although the assembly 10 is shown as including a brake pad 12 having two pistons 14 actuating it, the assembly 10 could also have a single piston 14 actuating the pad 12. The disc brake assembly 10 also includes a disc 16 and a caliper 18. Each piston 14 has a rear axial end 20 slidably mounted in a bore 22 in the caliper 18 and a front axial end 24 that faces the disc 16. The brake pad is disposed between the piston and the disc. A spring clip 32 connects to the brake pad 12 and the piston 14.

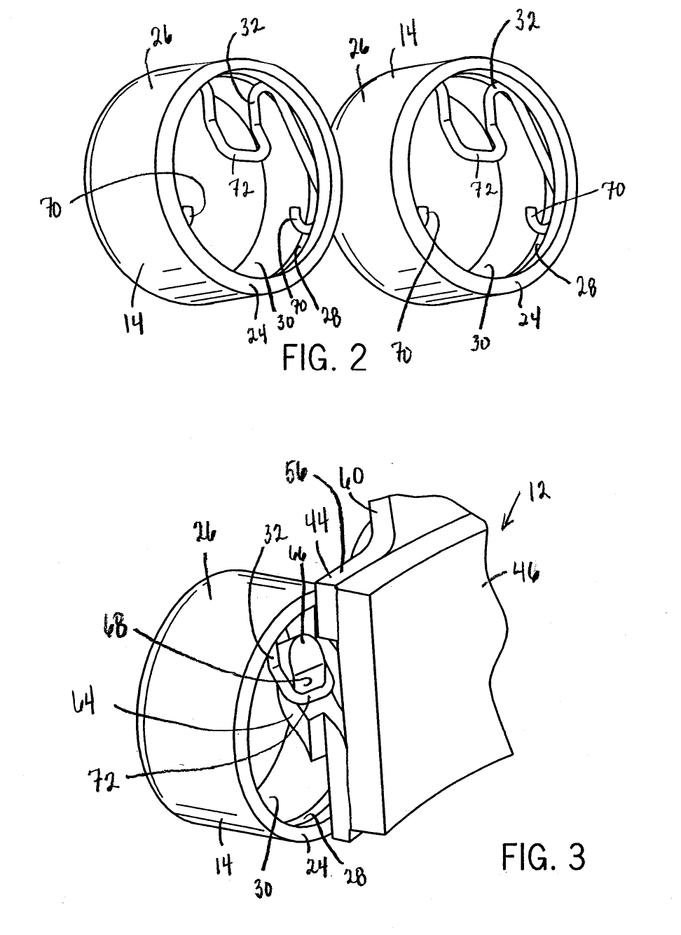

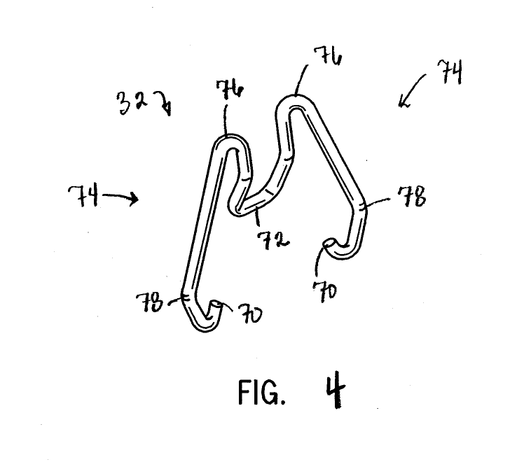

Referring additionally to FIGS. 2-3, each piston 14 includes a cylindrical peripheral surface 26 extending from the front end 24 to the rear end 20. An annular groove 28 is formed on an inner axial surface 30 at or near the front end 24 of the piston. The groove 28 receives portions of the spring clip 32 to provide multiple points of engagement between the spring clip 32 and the piston 14, as is shown in FIGS. 1 and 2. This is an advantage over the prior art brake of U.S. Pat. No. 6,003,639, which has only a single point of engagement between the spring clip and the piston.

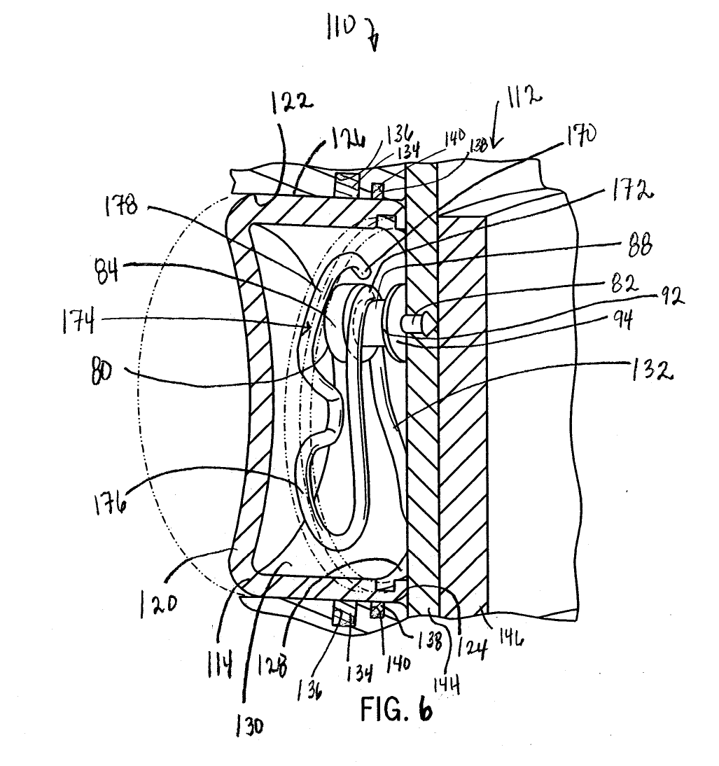

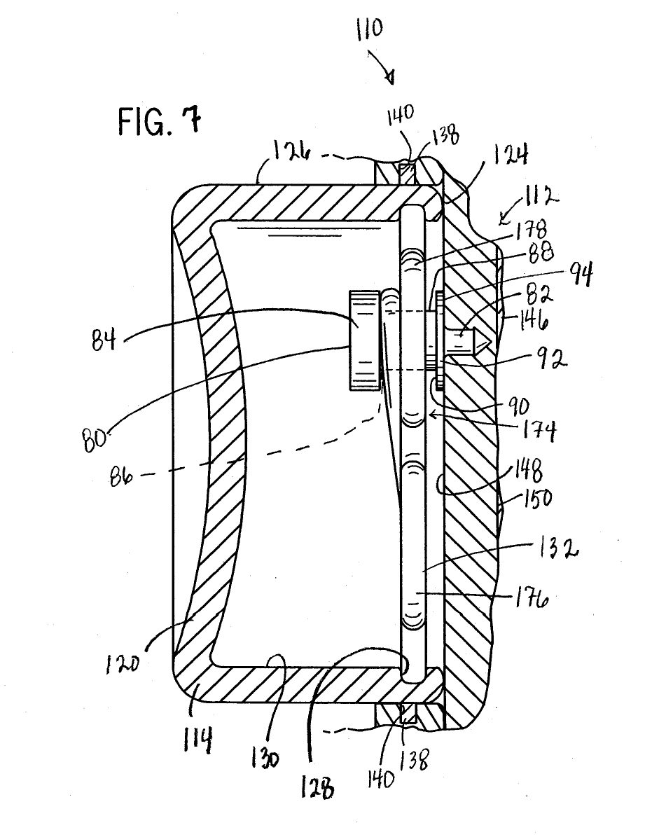

As is shown in FIGS. 5-6, an outer peripheral surface of the piston 14 is sealed in the bore 22 via seals 134 captured in grooves 136, respectively, in the wall of the bore 22. Wipers 138 are provided in grooves 140, respectively, in the bore 22 around the outer perimeter of the pistons 14 to wipe the outside surfaces of the pistons 14. A chamber 42 (FIG. 5) is formed between the rear end 20 of the piston 14 and an inner axial end of the bore 22. The chamber 42 can be selectively pressurized with hydraulic fluid that is introduced into the caliper 18 via a port (not shown) to drive the piston 14 towards the disc 16 to apply the brakes.

Referring back to FIGS. 1-3, each brake pad 12 includes a back plate 44 and a friction pad 46 made from a suitable friction material. The back plate 44 has a relatively flat rear surface 48, a relatively flat front surface 50, and left, right, upper, and lower side edges 52, 54, 56, and 58, respectively. The friction pad 46 is glued or otherwise affixed to the front surface 50 of the back plate 44. The back plate 44 has a tab 60 extending upwardly from the upper edge 56 of the back plate 44. The tab 60 includes an opening 62 that receives a pin (not shown).

As is best shown in FIG. 3, the back plate 44 includes a finger 64 that projects upwardly and outwardly from the center of the rear surface 48 of the back plate 44. The finger 64 includes a free end 66 and a valley 68 disposed perpendicular to the length of the finger 64. The finger 64 accepts the spring clip 32 as is described below.

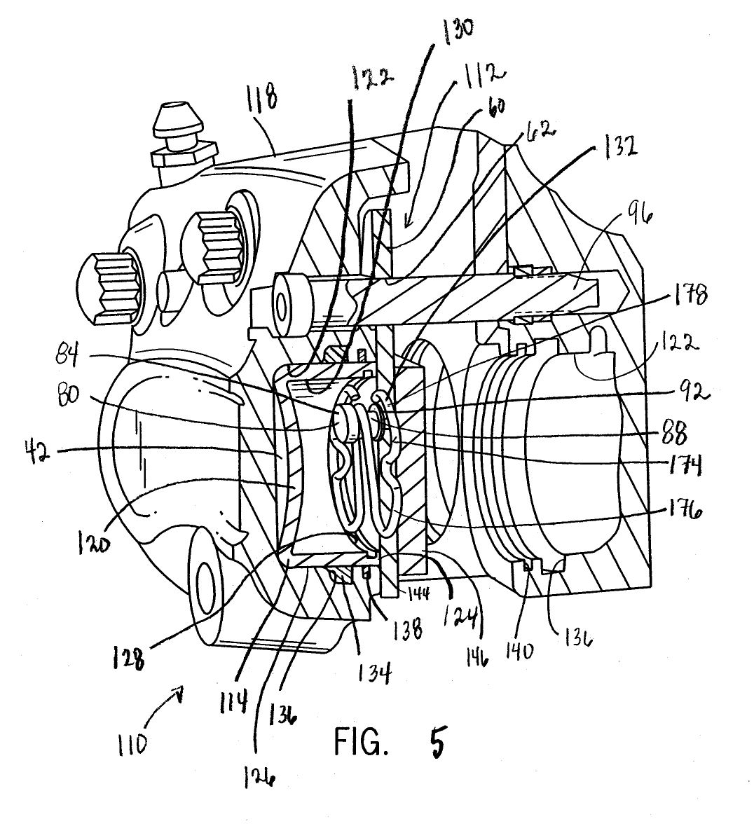

The brake pad 12 is securely clamped to the piston 14 by the spring clip 32, which is configured to permit the brake pad 12 to be installed in the assembly 10 and removed from the assembly 10 without using any special tools and without disassembling the brake system in any way. Towards these ends, the spring clip 32 takes the form of a wire form 32. Referring additionally to FIG. 4, the wire form 32 includes a pair of free ends 70 and a U-shaped loop 72 disposed intermediate the free ends 70. The loop 72 is bent toward the back plate 44 approximately half way down the loop 72. Piston engaging portions 74 are disposed between the loop 72 and the free ends 70. The piston engaging portions 74 are configured to extend substantially in parallel with the rear surface 48 of the back plate 44. Each of the piston engaging portions 74 includes two piston engaging sections 76 and 78 that are received in the groove 28 of the piston 14. Piston engaging sections 76 are located farther away from the loop 72, and piston engaging sections 78 are located closer to the free end 70 of the spring clip 32.

As is shown in FIG. 3, the loop 72 of the spring clip 32 fits under the finger 64 on the back plate 44 and is secured in the valley of the finger 64 to hold the wire form 32 in place on the back plate 44. When the loop 72 is fitted under the finger 64, the loop 72 is axially deflected with respect to free ends 70 of the spring clip 32.

The piston engaging sections 76 and 78 of the spring clip 32 are curved with a radius of curvature that generally matches the radius of curvature of the piston 14. However, the maximum undeflected distance between the section 78 on one side of the spring clip 32 and section 78 on the other side of the spring clip 32 is greater than the diameter of the inner axial surface 30 of the piston 14 so that the wire form 32 must deflect radially when the wire form 32 is inserted. This combination of radial and axial deflection minimizes or even eliminates movement of the brake pad 12 relative to the piston 14 both axially and radially, thereby preventing drag and rattle as well as unintended pad removal.

The brake pad 12 is installed simply by compressing the spring clip 32 by pushing the piston engaging sections 78 together. The spring clip 32 is placed inside the piston cavity. The piston engaging sections 76 are then inserted into the groove on the inner axial surface of the piston near the top of the piston. The piston engaging section 78 is aligned with the groove, and pressure on the piston engaging section 78 is released such that the spring clip 32 springs into the groove, and spring clip 32 is held therein.

The brake pad 12 is inserted from the bottom of the caliper, moved upwardly, and tilted so that the free end of the finger 64 aligns with the loop. As the pad is pushed into position, the finger 64 slips under the loop, displaces the loop slightly, and then allows the loop to fall into the valley of the finger 64. This produces a spring force that holds the pad tightly to the piston.

The brake pad 12 is removed from the piston and spring clip 32 by pulling the pad downwardly with a removal force that overcomes a retention force imposed on the brake pad 12 by the spring clip 32. The brake pad 12 is tilted as it is being pulled downwardly such that the spring clip 32 does not hit the piston.

### Second Embodiment of the Disc Brake Assembly

A second embodiment of the disc brake assembly 110 is shown in FIGS. 5-7. The brake assembly 110 of the second embodiment is substantially identical to the first embodiment of the disc brake assembly 10 except that it has a different spring clip 132 and a different back plate 144. Elements of the disc brake assembly 10 are, accordingly, designated by the same reference numeral incremented by 100. The disc brake assembly 110 includes a piston 114 and a brake pad 112 positively fixed to the piston 114 with a spring clip 132 such that the brake pad 112 is positively retracted away from a disc 116 of the disc brake assembly 110 when hydraulic pressure is released. The assembly 110 is shown in FIGS. 5-7 as a single piston 114 on each brake pad 112. However, the assembly 110 could also include two pistons 114 on each brake pad 112.

Each caliper 118 includes a bore 122 that slidably receives a rear axial end 20 of the piston 114. A front axial end 24 of the piston 114 faces the disc 116. The brake pad 112 is disposed between the piston 114 and the disc 116.

The back plate 144 has a relatively flat rear surface 148, a relatively flat front surface 150, and left, right, upper, and lower side edges 152, 154, 156, and 158, respectively. The friction pad 146 is glued or otherwise affixed to the front surface 150 of the back plate 144. The back plate 144 has a tab 160 extending upwardly from the upper edge 156 of the back plate 144. The tab 160 includes an opening 162 that receives a pin 96 (FIG. 5).

The back plate 144 includes a post 80 with a plate engaging portion 82 that is embedded in the back plate 144 via an interference fitting. The post 80 has a cap 84 provided on a free end 86 of the post 80 and a groove 88 partially defined by the cap 84. The groove 88 is further defined by a side 90 of an annular flange 92. The opposite side 94 of the annular flange 92 rests on the rear surface 148 of the back plate 144.

The brake pad 112 is securely clamped to the piston 114 by the spring clip 132. The spring clip 132 is configured to permit the brake pad 112 to be installed in the assembly 10 and removed from the assembly 110 without using any special tools and without disassembling the brake system in any way. Towards these ends, the spring clip 132 is preferably formed from a single piece of spring wire or “wire form.” The wire form 132 includes a pair of free ends 170, and a U-shaped loop 172 disposed intermediate the free ends 170. The loop 172 is bent away from the back plate 144. Piston engaging portions 174 are disposed between the loop 172 and the free ends 170. Piston engaging portions 174 are configured to extend substantially in parallel with the rear surface 148 of the back plate 144.

Each of the piston engaging portions 174 includes two piston engaging sections 176 and 178 that are separated by a radially inward curve and that are received in the groove 128 of the piston 114. Piston engaging sections 176 are located closer to the loop 172, and piston engaging sections 178 are located closer to the free end 170 of the spring clip 132. The loop 172 is slipped over the cap 84 of the post 80 and fits into the groove 88 of the post 80 to hold the wire form 132 in place.

The piston engaging sections 176 and 178 are curved with a radius of curvature that generally matches the radius of curvature of the piston 114. However, the maximum undeflected distance between section 178 on one side of the spring clip 132 and section 178 on the other side of the spring clip 132 is greater than the diameter of the inner axial surface 130 of the piston 114 so that the wire form 132 must deflect radially when the wire form 132 is inserted. This combination of radial and axial deflection minimizes or even eliminates movement of the brake pad 112 relative to the piston 114 both axially and radially, thereby preventing drag and rattle as well as unintended pad removal.

The brake pad 112 is installed simply by compressing the spring clip 132 by pushing the piston engaging sections 176 together and piston engaging sections 178 together. The spring clip 132 is placed inside the piston cavity. The piston engaging sections 176 are then inserted into the groove 128 on the inner axial surface 130 of the piston 114 near the top of the piston 114. The piston engaging sections 178 are aligned with the groove 128 of the piston 114, and pressure on the piston engaging sections 178 is released such that the spring clip 132 springs into the groove 128, and spring clip 132 is held therein.

The brake pad 112 is inserted from the bottom of the caliper 118, moved upwardly, and tilted so that the 80 post aligns with the loop 172. As the brake pad 112 is pushed into position, the cap 84 of the post 80 slips under the loop 172, displaces the loop 172 slightly, and then allows the loop 172 to fall into the groove 88 of the post 80. This produces a spring force that holds the brake pad 112 tightly to the piston 114.

The brake pad 112 is removed from the piston 114 and spring clip 132 by pulling the brake pad 112 downwardly with a removal force that overcomes a retention force imposed on the brake pad 112 by the spring clip 132. The brake pad 112 is tilted as it is being pulled downwardly such that the spring clip 132 does not hit the piston 114.

In both embodiments of the disc brake assembly 10 and 110, the brake pad 12 and 112 retracts with the piston 14 and 114 away from the disc 16 and 116 when brake system hydraulic pressure is released. With the brake pad 12 and 112 retracting away from the disc 16 and 116, the chance of parasitic drag between disc 16 and 116 and pad 12 and 112 is reduced or eliminated. This advantageously increases the performance of the disc brake assembly 10 and 110, increases fuel economy, and increases brake pad 12 and 112 life due to lower running temperatures achieved because the brake pad 12 and 112 spends less time in contact with the disc 16 and 116 and air can cool the brake pad 12 and 112. This also lowers the virtual inertia of the wheel, making the wheel act lighter. In antilock brake systems, this feature provides the benefit of releasing the wheel sooner than without this. The disc brake assembly 10 and 110 described herein also lessens or eliminates the aforementioned known problems in the prior art. For example, the assemblies 10 and 110 cost less to manufacture than previous assemblies employing spring clip.

By this invention, a brake pad 12 and 112 is fixed to a piston 14 and 114 through the use of a spring or the like, which allows the brake pad 12 and 112 to retract with the piston 14 and 114 away from the disc 16 and 116 when the brake system pressure is released.

Many changes and modifications can be made in the invention without departing from the spirit thereof. The scope of some of these changes is discussed above. The scope of the remaining changes will be apparent from the appended claims.

What is claimed is:

1. A disc brake assembly comprising:
(A) a disc;
(B) a caliper;
(C) a piston having a rear end slidably mounted in a bore in the caliper, a front end that faces the disc, and an inner axial surface;
(D) a brake pad comprising 1) a back plate having front and rear surfaces and 2) a friction pad mounted on the front surface of the back plate, the brake pad disposed between the piston and the disc; and
(E) a spring clip that is configured to be connectable to the rear surface of the back plate and that engages the inner axial surface of the piston.

2. The disc brake assembly of claim 1, wherein the spring clip comprises a wire form.

3. The brake disc assembly of claim 1, wherein the spring clip has 1) a pair of free ends and 2) a loop that is disposed intermediate the free ends and that is configured to be connectable to the rear surface of the back plate.

4. The disc brake assembly of claim 2, wherein the spring clip has two piston engaging portions each disposed between the loop and a respective free end, each of the piston engaging portion including two spaced apart piston engaging sections, and each of the piston engaging portions cooperating with an associated side of the piston.

5. The disc brake assembly as defined in claim 4, wherein at least part of the piston engaging portions have a radius of curvature that at least generally matches a radius of curvature of the piston.

6. The disc brake assembly of claim 1, wherein the inner axial surface of the piston comprises a radial groove that is configured to receive the spring clip.

7. The disc brake assembly of claim 1, wherein the back plate comprises a finger situated on the rear surface, and wherein the spring clip includes a loop that is configured to be connectable to the finger.

8. The disc brake assembly of claim 1, wherein the back plate comprises a post situated on the rear surface, and wherein the spring clip includes a loop that is configured to be connectable to the post.

9. The disc brake assembly of claim 7 wherein the finger comprises a valley that is configured to receive the loop.

10. The disc brake assembly of claim 1, wherein the caliper is a floating caliper.

11. The disc brake assembly of claim 1, wherein the caliper is a fixed caliper.

12. The disc brake assembly of claim 1, wherein the caliper includes a plurality of bores, each of which has a rear end of a piston slidably mounted therein.

13. A disc brake assembly comprising:
(A) a disc;
(B) a caliper;
(C) a piston having a rear end slidably mounted in a bore in the caliper, a front end that faces the disc, and an inner axial surface;
(D) a brake pad comprising 1) a back plate having front and rear surfaces, the back plate including a structure situated on the rear surface of the back plate and 2) a friction pad mounted on the front surface of the back plate, the brake pad disposed between the piston and the disc; and
(E) a spring clip that is configured to be connectable to 1) the structure situated on the rear surface of the back plate and 2) the piston.

14. The disc brake assembly of claim 13, wherein the structure situated on the rear surface of the back plate comprises a finger.

15. The disc brake assembly of claim 14, wherein the finger comprises a valley, and wherein the spring clip includes free ends and a loop disposed between the free ends, the loop being configured to be connectable to the valley of the finger.

16. The disc brake assembly of claim 13, wherein the caliper is a floating caliper.

17. The disc brake assembly of claim 13, wherein the caliper is a fixed caliper.

18. The disc brake assembly of claim 13, wherein the caliper includes a plurality of bores, each of which has a rear end of a piston slidably mounted therein.

19. A method comprising
(A) compressing a spring clip;
(B) aligning the compressed spring clip with a groove on an inner axial surface of a piston of a brake assembly;
(C) releasing compression force on the spring clip such that the spring clip fits into the groove of the piston; and
(D) securing a brake pad to the spring clip.

20. The method of claim 19, wherein the securing step comprises connecting a structure on the brake pad to the spring clip.

21. The method of claim 19, wherein the structure comprises a finger situated on a rear surface of the brake pad, and wherein the spring clip includes a loop that is configured to be connectable to the finger.

22. The method of claim 19, wherein the structure comprises a post situated on the rear surface, and wherein the spring clip includes a loop that is configured to be connectable to the post.

23. The method of claim 19, wherein during the securing step, the spring clip draws the brake pad tight against the piston so that the brake pad and piston move together as a unit.

24. The method of claim 19, wherein the brake assembly includes a caliper, and
further comprising removing the pad from the spring clip without detaching the spring clip from the piston, by pulling the brake pad at least generally radially relative to the caliper with a removal force that overcomes a retention force imposed on the brake pad by the spring clip.

25. The method of claim 19, wherein the brake assembly includes a disc and a caliper that faces the disc and that supports the brake pad, and
further comprising removing the brake pad from the spring clip without removing the caliper or the disc from the brake assembly, by pulling the pad at least generally radially relative to the caliper with a removal force that overcomes a retention force imposed on the pad by the spring clip.

26. The method of claim 25, wherein, when the piston extends horizontally, the removing step comprises pulling the pad at least generally vertically downwardly with a force that overcomes a retention force imposed by the spring clip.

27. The disc brake assembly of claim 19, further comprising slidably mounting the piston in a floating caliper.

28. The disc brake assembly of claim 19, further comprising slidably mounting the piston in a fixed caliper.

29. The disc brake assembly of claim 19, wherein the brake assembly includes a caliper having a plurality of bores, each of which has a rear end of a piston slidably mounted therein.
